(19) United States
(12) Patent Application Publication
(10) Pub. No.: US 2006/0147701 A1
(43) Pub. Date: Jul. 6, 2006

(54) Conductive polymer layer articles and method

(75) Inventor: James E. Lockridge, Minneapolis, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/026,281

(22) Filed: Dec. 30, 2004

(51) Int. Cl. B32B 5/16; B32B 9/04

(52) U.S. Cl. 428/323; 428/411.1

(57) ABSTRACT

The present invention relates to conductive layers, conductive (e.g. sheet or film) material, methods of making conductive layers, and articles such as touch screens.

### BACKGROUND

Touch sensors provide an interface between an electronic system and operator. Rather than using a keyboard to type in data, for example, touch sensors allow the user to transfer information to a computer by touching a displayed icon, or by writing or drawing on a screen. In many applications a transparent touch screen is positioned over a display.

Several types of transparent touch sensors use resistive or capacitive techniques to detect touch location. A resistive touch sensor includes two layers of transparent conductive material, such as a transparent conductive oxide, separated by a gap. (See for Example U.S. Patent Application Publication US2003/0170456.) When touched with sufficient force, one of the conductive layers flexes to make contact with the other conductive layer. The location of the contact point is detectable by controller circuitry that senses the change in resistance at the contact point.

Resistive touch sensors operate based on actual contact between the conductive layers. As a touch panel is used, repeated mechanical flexing and compressions can cause breaks and/or delamination of the conductive layer. Such mechanical failures alter the resistance measured at least at the position of the failure, resulting in a failure of the touch screen to correctly identify the location of touch (e.g. the item being selected).

Accordingly, industry would find advantage in touch screens and conductive sheet materials having improved properties.

### SUMMARY

In one aspect, the invention relates to a touch screen comprising a first and a second conductive layer separated by a gap wherein at least one conductive layer comprises a conductive polymer and nonconductive particles, and wherein the nonconductive particles do not provide electrical isolation of the first conductive layer from the second conductive layer. The touch screen preferably exhibits a durability of at least 5,000 rubs (e.g. at least 50,000 rubs or at least 75,000 rubs) according to the Rub Durability Test.

In another aspect, the invention relates to a conductive sheet comprising a conductive layer disposed on a substrate, wherein the conductive layer comprises a polymeric binder matrix comprising conductive polymer and nonconductive particles, and wherein the nonconductive particles do not provide electrical isolation of the conductive layer.

In another aspect, the invention relates to a method of making a conductive sheet comprising providing a substrate, providing a composition comprising a mixture of polymeric binder, conductive polymer and nonconductive particles, and disposing the composition onto the substrate. The conductive composition forms a conductive layer. The nonconductive particles do not provide electrical isolation of the conductive layer. The composition is typically provided as a coating composition further comprising a solvent.

In each of these aspects, the conductive composition is preferably disposed at a thickness between particles (e.g. 120 nm to 520 nm) that is less than the particle size of the nonconductive particles. Further, the nonconductive particles have a mean particle size of less than 10 micrometers and preferably from about 0.2 micrometers to 2 micrometers. The nonconductive particles may comprise a polymeric material, such as polystyrene; an inorganic material, such as silica; or combinations thereof. The nonconductive particles are typically substantially spherical. A primer layer is preferably disposed between the substrate and the conductive layer.

### BRIEF DESCRIPTION OF THE DRAWINGS

The invention may be more completely understood in consideration of the following detailed description of various embodiments of the invention in connection with the accompanying drawings, in which:

FIG. 1 schematically illustrates a cross-section of the conductive layers of a touch sensor in accordance with an embodiment of the invention.

FIG. 2 schematically illustrates a cross-section of a conductive layer in accordance with an embodiment of the invention.

### DETAILED DESCRIPTION OF THE PREFERRED EMBODIMENTS

In the following description of the illustrated embodiments, references are made to the accompanying drawings that form a part hereof, and in which is shown by way of illustration, various embodiments by which the invention may be practiced. It is to be understood that other embodiments may be utilized, and structural and functional changes may be made without departing from the scope of the present invention.

The present invention relates to conductive layers, conductive (e.g. sheet or film) materials, methods of making conductive layers, and articles such as touch screens. Although a resistive touch sensor is exemplified, the conductive layer described herein can be employed in capacitive touch sensor articles as well.

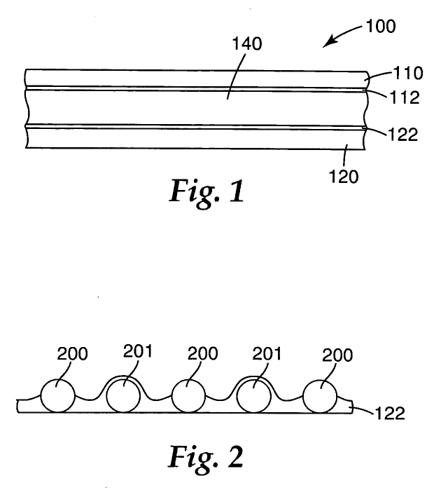

A typical resistive touch sensor is illustrated in FIG. 1. The touch sensor 100 includes, at least, a first conductive layer 112, typically provided on a first (e.g. top) substrate 110, and a second conductive layer 122 typically provided on a second (e.g. bottom) substrate 120, separated by a gap 140. The conductive layer can be continuous over the active area of the touch sensor or can be discontinuous (e.g. patterned). Prior to a touch, the conductive layers 112, 122 are separated, as shown in FIG. 1. The conductive layers are thus electrically isolated until a sufficient touch force is applied, and are electrically isolated upon removal of the sufficient touch force.

The substrates can be made of any suitable material, and are generally highly electrically insulating as compared to the conductive layers. Glass, ceramic materials, flexible plastic sheets or films, rigid plastics, and other such materials can be used. Suitable plastic materials include for example acrylic-containing film, a poly(vinyl chloride)-containing film, a poly(vinyl fluoride)-containing film, a urethane-containing film, a melamine-containing film, a polyvinyl butyral-containing film, a cellulose acetate-containing film, a polyolefin-containing film, a polyester-containing film and a polycarbonate-containing film.

In many applications, the touch sensor is provided as an overlay for an electronic display. For this embodiment, at least the substrate at the viewing surface is substantially transmissive of visible light. In other applications wherein graphics, text, or other indicia are provided between the user and the touch sensor, transparent substrate materials may not be required.

At least one of the substrate/conductive layer combinations is flexible, to allow deformation in response to an applied touch force, so that contact can be made between the first and second conductive layers within an area that corresponds to the characteristics of the touch input (location, size of touch implement, force of touch, etc.). Upon making electrical contact between the conductive layers, a signal can be measured that can be used to locate the position of the touch input, as is well known in the art. The other substrate/conductive layer combination can be rigid or flexible. If both substrates are flexible, it is preferred that the touch sensor be mounted onto a rigid support, for example onto the front glass plate of an electronic display screen.

Various approaches have been described for providing gap 140 between the first and second conductive layers. The gap can comprise air or another gas, a liquid, or a deformable and resilient material. For example, U.S. Pat. No. 6,469,267 describes maintaining an air gap with spacer elements. In another approach, spacer strips may be employed as described in U.S. Pat. No. 5,062,198. In yet another approach, microstructured conductive layers can be employed as described in U.S. 2004/0012570. In yet other patents, gap-filling materials may be employed, such as described in WO 03/094186 and WO 2004/010277.

Although any technique can be utilized for providing the gap, the inclusion of spacer elements is typically preferred. As further described in US 2003/0170456, microspheres (i.e. substantially spherical beads), are suitable spacer elements for providing separation between the conductive layers. The microsphere spacer elements have a diameter greater than 10 micrometers and typically at least 20 micrometers.

With reference to FIG. 2, described herein is a conductive layer (e.g. 112 and/or 122) that comprises at least one conductive polymer, typically provided in a polymeric matrix and a plurality of nonconductive particles 200 and 201. In order that the nonconductive particles maintain their particulate form, the nonconductive particles are insoluble in the conductive polymer layer.

Unlike spacer elements, however, the nonconductive particles do not provide electrical isolation of the conductive layer(s), e.g. with a second conductive layer. Accordingly, the nonconductive particles do not detract from the conductivity through or within the conductive layer nor detract from the electrical contact between (i.e. separated) conductive sheets when a touch force is applied.

Without being bound by theory, it is believed that this is accomplished by employing particles (e.g. microspheres) that are substantially smaller in size than spacer elements and/or a sufficient portion of the nonconductive particles are coated with the conductive layer such as depicted by nonconductive particles 201.

In at least some embodiments, the conductive layer exhibits improved durability. The Applicant surmises that the inclusion of such nonconductive particles diminishes the occurrence of Newton's rings. Further, the inclusion of the nonconductive particles also diminishes the visibility of optical defects.

The nonconductive particles have a mean particle size of less than 10 micrometers, preferably less than 8 micrometers, and more preferably less than 5 micrometers. Further, nonconductive particles have a mean particle size of at least 0.2 micrometers and preferably at least 0.4 micrometers.

The nonconductive particles have a mean particle size that is greater than the thickness of the conductive layer between particles. The conductive layer typically has a thickness between particles of at least about 120 nanometers. Further, the conductive layer typically has a thickness between particles of no greater than about 520 nanometers. For a thickness of about 370 nanometers, the nonconductive particles typically have a mean particle size ranging from 0.4 micrometers to 1.8 micrometers. The particle size distribution of the nonconductive particles may vary. However, it is typically preferred that the nonconductive particle have a relatively narrow particle size distribution.

The concentration of the nonconductive particles in the conductive layer is at least 0.2 wt-%, typically at least 1 wt-%, more typically at least 2 wt-%, even more typically at least 5 wt-% and more typically at least 10 wt-% of the conductive layer. The concentration of the nonconductive particles is typically less than 40 wt-% (e.g. 30 wt-%, 25 wt-%) and more typically less than 20 wt-% of the conductive layer. The concentration is selected based on maximizing the durability while concurrently minimizing the occurrence of Newtons' rings.

Various nonconductive particles and mixtures thereof may be utilized in the conductive layer. The particles may have various regular and irregular shapes with spherical shapes being common. Nonconductive particles of a suitable size are commercially available. Alternatively, nonparticulate materials can be ground and separated, as known in the art, to obtain the desired particle size.

In some embodiments, the nonconductive particles comprise a polymeric material. Suitable polymeric material includes various thermoplastic and thermosetting resins such as polystyrene, polymethylmethacrylate, melamine, etc. Suitable polymeric nonconductive particles include 4 micron polymethylmethacrylate beads, 4 micron melamine resin beads, and 3 micron polystyrene beads commercially available from Sigma-Aldrich, Milwaukee, Wis. under the catalog numbers of “73371”, “90639” and “79166”. Suitable 3 micron polystyrene beads are also commercially available from Polysciences, Inc., Warrington, Pa. under the trade designation “Polybead” (catalog number 17134).

Polymeric nonconductive particles are selected based on the conductive layer composition (e.g. polymeric binder). Although the nonconductive particles are insoluble, concurrently the nonconductive particles are sufficiently compatible such that the conductive composition adequately adheres to the nonconductive particles. In one aspect, this can be accomplished by selecting a polymeric nonconductive particle that is comprised on the same material as the polymeric binder, yet higher in molecular weight (Mw).

Although nonconductive polymeric materials diminish the occurrence of Newton's rings in combination with some enhancement in durability, inorganic nonconductive particles are preferred for obtaining yet higher improvements in durability. Suitable inorganic particles including silica, alumina, titanium oxide, zirconium oxide, as well as various hollow and solid glass microspheres. Suitable silica particles are commercially available from Nyacol Nano Technologies, Ashland, Mass. under the trade designations “Nyasil 20” or “Nyasil 5”. Suitable 3 micrometer inorganic silica microspheres are commercially available from Polysciences under the catalog number 24330. As is known in the art, various inorganic particles are available with functionalized surfaces to improve adhesion to polymeric binders.

The “Rub Durability” of a conductive sheet or touch sensor can be evaluated by use of various techniques. The Rub Durability as measured according to the test method described in the forthcoming examples is at least 5,000 rubs until the phase angle is greater than 2 degrees. In some embodiments, the Rub Durability is at least 10,000 rubs,. at least 20,000 or at least 50,000 rubs until the phase angle is greater than 2 degrees. In preferred embodiments, the Rub Durability is at least 75,000 rubs and may exceed even 250,000 rubs until the phase angle is greater than 2 degrees. A phase angle of greater than 2 degrees is indicative of the onset of a significant reduction in conductivity of the conductive layer prior to failure. The number of rubs to failure can be significantly greater, for example four times that to produce a phase angle of greater than 2 degrees (e.g. greater than 1 million rubs).

Various conductive polymers are known. Suitable conductive polymers include for example substituted and unsubstituted polypyrrole, polyaniline, polyacetylene, polythiophene, polyphenylene vinylene, polyphenylene sulfide, poly p-phenylene, polyheterocycle vinylene, and materials disclosed in European Patent Publication EP-1-172-831-A2. One preferred conductive copolymer is polyethylenedioxythiophene polystyrenesulfonate (PEDT:PSS), commercially available from H. C. Starck, Leverkusen, Germany, under the trade designation “Baytron P.”

The conductive polymer and nonconductive particles are typically provided in a polymeric binder matrix. The polymeric matrix imparts desired mechanical properties to the conductive polymer material. Suitable polymeric materials include, but are not limited to, water-soluble or water-dispersible polymers such as gelatin, gelatin derivatives, maleic acid or maleic anhydride copolymers, cellulose derivatives (such as carboxymethyl cellulose, hydroxyethyl cellulose, cellulose acetate butyrate, diacetyl cellulose, and triacetyl cellulose), polyvinyl alcohol, poly-N-vinylpyrrolidone, and sulfonated polyester. Other suitable binders include organic solvent soluble or polar solvent soluble (e.g. alcohol soluble) as well as aqueous emulsions of addition-type homopolymers and copolymers prepared from ethylenically unsaturated monomers such as acrylates including acrylic acid, methacrylates including methacrylic acid, acrylamides and methacrylamides, itaconic acid and its half-esters and diesters, styrenes including substituted styrenes, acrylonitrile and methacrylonitrile, vinyl acetates, vinyl ethers, vinyl-and vinylidene halides, and olefins; and solvent soluble or aqueous dispersions of polyurethanes or polyesterionomers; or a polysiloxane. The weight ratio of the conductive polymer to polymeric binder matrix is between 1 to 99 and 99 to 1, with a ratio between 9 to 1 and 1 to 9 being typical. A suitable crosslinker is typically added, based on the particular polymeric binder or combination thereof, thereby forming a crosslinked polymeric matrix.

One preferred binder is an ethylenically unsaturated binder precursor that is cured, for example, with ultraviolet light. Various ethylenically unsaturated binder precursors are known such as those described in U.S. Pat. No. 6,299,799.

The conductive layer can suitably be prepared using various various known techniques such as spin-coating, coating from a flat film die, knife coating, dip coating, spray coating, electrostatic spray coating, roll coating, printing and similar processes. Web coating, spin coating, and electro-coating techniques have been demonstrated to disperse both conductive polymers and polymeric binder materials.

Coating from solution is generally preferred. In greater detail, it is typically preferred to dissolve the conductive polymer in a suitable solvent and then combine the solution with the polymeric binder (e.g. precursor). The nonconductive particle is typically added to the conductive polymer/binder solution. The choice of solvent is dependent upon the conductive polymer (e.g. copolymer thereof). In the case of polyethylenedioxythiophene polystyrenesulfonate conductive polymer, polar aprotic solvents such as N-methylacetamide (NMAC) are preferred. Further details concerning the preparation of the conductive polymer coating solution are described in concurrently filed patent Application attorney docket no. FN56390US002, incorporated herein by reference

### EXAMPLES

### Conductive Coating Layer Solution

20 grams of N-methylacetamide (NMAC) was heated to about 30° C. and added dropwise with stirring to 80 grams of polyethylenedioxythiophene polystyrenesulfonate (PEDT:PSS), commercially available from H. C. Starck, Leverkusen, Germany under the trade designation “Baytron P”. The solution was then cooled to approximately 15° C. The following solvents were then added dropwise: 20 grams of ethanol, 30 grams of iso-propanol (IPA), and 92.8 grams of n-butanol. Finally, 15 grams of a pre-mix of 10% acrylate, commercially available from Sartomer, West Chester, Pa., under the trade designation “SR444” and 0.25% of photoinitiator commercially available from BASF, Mt. Olive, N.J. under the trade designation “Lucirin TPO” in IPA was added drop-wise with stirring. This solution was then stirred for approximately 10 minutes. 10-16 mg of nonconductive beaded particle material, as described in Table 1, was then added to 10 grams of vigorously stirred conductive polymer coating solution. The solutions were then placed in an ultrasonic bath for approximately 10 minutes.

Conductive coatings were prepared by coating the described solutions onto a pre-primed polyethyleneterephthalate (PET) film, (the pre-primed PET was prepared by coating length-oriented PET with a PVDC solution (WR Grace, Cambridge, Mass. under the trade designation “Daran SL112”) followed by crossweb stretching the film, commonly known as tentering). The pre-primed PET was then coated with the indicated conductive polymer solution using a #20 wire-wound Meyer-rod. The coating was allowed to dry at room temperature for 3 minutes. The samples were then placed in a 120° C. oven with impinging airflow for approximately 15 minutes. Finally, the coatings were cured with ultraviolet lights in a nitrogen-inert atmosphere under a 300-watt D-type bulb at a rate of 15 ft/min. The thickness of the cured conductive polymer layer was approximately 370 nm.

Each of the four conductive polymer compositions were subject to “Rub Durability Testing” as described as follows:

Rub Durability Testing Method:

Two sheets of the pre-primed PET film coated with the same conductive layer, measuring approximately 4″×6″ (10 cm×15 cm) were used. The sheets were stacked with the conductive layers facing each other with spacers applied to mimic spacer elements. Each sheet was connected through a copper bar to a test fixture capable of measuring the electrical properties of the touch screen mock-up. The test fixture applies an AC voltage (approximately 5V) to one sheet and measure the current impedance phase angle capacitance and resistance between the two sheets. A third sheet of 7 mil PET was used between the top conductive sheet and the Personal Data Assistant Stylus. Mechanical stress was applied by rubbing a Personal Data Assistant stylus back and forth across a 1 inch (2.54 cm) section of the film. The stylus pressure was 250 g and the rate of rubbing was 54 cycles/minute. When good electrical contact occurs between the top and bottom conductive layers, the phase angle and capacitance are zero and the resistance is equal to the impedance. When damage occurs to the conductive layers, the capacitance and phase angles become non-zero and the resistance and impedance are no longer equal.

Table 1 as follows shows the number of rub cycles endured by the conductive coatings until the phase angle becomes greater than 2 degrees. Examples 1-4 comprise nonconductive particles dispersed within the conductive polymer layer. Comparative Example A comprises a conductive film coated with the same conductive polymer, polyethylenedioxythiophene polystyrenesulfonate (PEDT:PSS), commercially available from Agfa Corporation, Mortsel, Belgium under the trade designation “Agfa EL 1500”.

TABLE 1

| | | Wt % | | Rubs to |
|---|---|---|---|---|
| Nonconductive | | Particles | Nonconductive | Phase |
| Particle Trade | | in dried | Particle Size | Angle |
| Designation | Composition | coating | (micrometers) | Shift >2° |
| Example 1 | Silica | 15.8 | 1.4 | 309,000 |
| “Nyasil 20” | | | | |
| Example 2 | Silica | 14 | 1.8 | 103,000 |
| “Nyasil 5” | | | | |
| Example 3 | Polymethyl- | 12.5 | 4 | 16,000 |
| | methacrylate | | | |
| Example 4 | Polystyrene | 11.4 | 0.4 | 41,000 |
| Comparative A | No | | | 800-1500 |
| | Nonconductive | | | |
| | Particles | | | |

The initial resistance of the conductive sheets having the conductive layer compositions of Example 1 and 2 were tested using the same fixture as described in the Rub Durability with the exception that spacer elements were not employed. Low resistance was observed between sheets. Accordingly, the conductive sheets would not be suitable for use in a resistive touch screen without a means for providing a gap, such as spacer elements.

The present invention should not be considered limited to any particular examples described above, but rather should be understood to cover all aspects of the invention as fairly set out in the attached claims. Various modifications and equivalent processes, as well as numerous structures to which the present invention may be applicable will be readily apparent to those of skill in the art to which the present invention is directed upon review of the instant specification.

What is claimed is:

1. A touch screen comprising a first conductive layer and a second conductive layers separated by a gap, wherein at least one of the conductive layers comprises a conductive polymer and nonconductive particles, and wherein the nonconductive particles do not provide electrical isolation of the first conductive layer from the second conductive layer.

2. The touch screen of claim 2 wherein the conductive polymer is dispersed in a polymeric binder matrix.

3. The touch screen of claim 1 wherein the screen exhibits a durability of at least 5,000 rubs according to the Rub Durability Test.

4. The touch screen of claim 1 wherein the screen exhibits a durability of at least 50,000 rubs according to the Rub Durability Test.

5. The touch screen of claim 1 wherein the screen exhibits a durability of at least 75,000 rubs according to the Rub Durability Test.

6. The touch screen of claim 1 wherein at least one substrate is transparent.

7. The touch screen of claim 1 wherein the nonconductive particles have a mean particle size and the conductive layer has a thickness between particles that is less than the mean particle size of the nonconductive particles.

8. The touch screen of claim 1 wherein the conductive layer has a thickness between particles ranging from 120 nm to 520 nm.

9. The touch screen of claim 1 wherein the nonconductive particles have a mean particle size of less than 10 micrometers.

10. The touch screen of claim 1 wherein the nonconductive particles have a mean particle size ranging from about 0.2 micrometers to 2 micrometers.

11. The touch screen of claim 1 wherein the nonconductive particles comprise a polymeric material.

12. The touch screen of claim 11 wherein the nonconductive particles comprise a material selected from the group consisting of polystyrene, polymethylmethacrylate, melamine, and combinations thereof.

13. The touch screen of claim 1 wherein the nonconductive particles comprise an inorganic material.

14. The touch screen of claim 13 wherein the nonconductive particles comprise silica.

15. The touch screen of claim 1 wherein the nonconductive particles are substantially spherical.

16. A conductive sheet comprising
a conductive layer disposed on a substrate, wherein the conductive layer comprises conductive polymer and nonconductive particles having a mean particle size ranging from about 0.2 micrometers to 10 micrometers, and wherein the nonconductive particles do not provide electrical isolation of the conductive layer.

17. The conductive sheet of claim 16 wherein the conductive polymer is dispersed in a polymeric binder matrix.

18. The conductive sheet of claim 16 further comprising a primer layer disposed between the substrate and the conductive layer.

19. A method of making a conductive sheet comprising:
providing a substrate;
providing a composition comprising a mixture of polymeric binder, conductive polymer and nonconductive particles; and
disposing the composition onto the substrate forming a conductive layer wherein the nonconductive particles do not provide electrical isolation of the conductive layer.

20. The method of claim 1 wherein the composition is provided as a coating composition further comprising a solvent.
